(19) United States
(12) Patent Application Publication
(10) Pub. No.: US 2010/0315383 A1
(43) Pub. Date: Dec. 16, 2010

(54) TOUCH SCREEN ADOPTING AN OPTICAL MODULE SYSTEM USING LINEAR INFRARED EMITTERS

(75) Inventors: Keun Ho Chang, Daejeon (KR); Dong Hwan Cho, Daejeon (KR); Young Jin Jeong, Daejeon (KR)

Correspondence Address: LADAS & PARRY LLP, 224 SOUTH MICHIGAN AVENUE, SUITE 1600, CHICAGO, IL, 60604, US

(73) Assignee: HOGAHM TECHNOLOGY CO., LTD., Daejeon (KR)

(21) Appl. No.: 12/918,556

(22) PCT Filed: Oct. 12, 2009
(86) PCT No.: PCT/KR2009/005833

§ 371 Date: Aug. 20, 2010

(30) Foreign Application Priority Data
Oct. 13, 2008 (KR) 10-2008-0100111

(51) Int. Cl. G06F 3/042

(52) U.S. Cl. 345/175

(57) ABSTRACT

Disclosed is an optical modular touch screen using a linear infrared emitter, in which the linear infrared emitter is disposed at each of three or four sides of a rectangular frame defining the touch screen, and infrared rays emitted from the linear infrared emitter is detected through two or three optical modules, thereby recognizing a shadow generated by finger touch and grasping a position thereof.

The optical modular touch screen of the present invention includes a linear infrared emitter 40 which is independently disposed at least three sides 20b, 20c, 20d of frame 20 of a rectangular image screen 10 so as to emit the infrared rays; an optical module 30 which is disposed at least two or more corner portions so as to monitor the entire image screen 10; a control board 50 which analyzes an infrared signal detected by the optical module 30 and detects the touch position touched by a user.

### TECHNICAL FIELD

The present invention relates to an optical modular touch screen, and more particularly, to an optical modular touch screen using a linear infrared emitter, in which the linear infrared emitter is disposed at each of three or four sides of a rectangular frame defining the touch screen, and infrared rays emitted from the linear infrared emitter is detected through two or three optical modules, thereby recognizing a shadow generated by finger touch and grasping a position thereof.

### BACKGROUND ART

In general, a touch screen responds to touch (contact) of a finger, a touch pen and the like and then grasps a touch position when an image displayed on an image screen is touched by the finger, the touch pen and the like.

The touch screen is manufactured to be covered on a flat display LCD panel or a PDP panel. The touch screen is a device which detects a touch position of a finger independent of an image displayed on the image screen and converts the touch position into coordinates on the image screen. The coordinate information is transferred to a computer for controlling the image. The computer composes the image and the position information received from the touch screen and then controls the image to be corresponded appropriately. As applications of the touch screen, there are an automated teller machine (ATM) in a bank, a ticket vending machine in a train station, a mobile information device, a mobile phone and so on. Furthermore, the touch screen is drawing attention as an educational device.

As a method of embodying the touch screen, there are some technically different manners according to a screen size and a purpose, which includes a resistive type, an electrostatic type, a surface acoustic wave type, an infrared type, an optical module (or camera) type and the like.

FIG. 1 shows a construction of a conventional optical modular touch screen.

In the conventional optical modular touch screen, as shown in FIG. 1, a subminiature optical module 3 monitoring the screen with a visual angle of 90° is disposed at both ends of one side of a rectangular frame 2 for supporting an image screen 1, and a plurality of infrared LEDs 4 emitting infrared rays are thickly arranged at the other three sides of the rectangular frame 2, and a control board 5 is provided at one side of the rectangular frame 2 or inside a display device, on which the touch screen is installed, so as to control the optical modules 3 and the infrared LEDs 4 and analyze an image detected by the optical module 3 and thus grasp a touch position.

In the touch screen as described above, the infrared rays are emitted from the plurality of infrared LEDs 4 arranged at the three sides of the rectangular frame 2, and the optical modules 3 disposed at the two corners receives the infrared rays emitted from the infrared LEDs 4. In this situation, if a user's finger (or a touch pen) touches the image screen 1, a passage of the infrared rays from the three sides of the frame 2 to the optical module 3 is partially blocked. The two optical modules 3 disposed at different positions detect a shadow of the finger as an angular line of the optical module 3, and the control board 5 processes the angle information of the optical module received from the two optical modules 3 and converts the touch position into coordinates. The coordinate information calculated from the control board is transferred to a computer for controlling a display device, and the computer controls the coordinates of the touch position to be appropriately corresponded and displayed on the image screen 1.

In the conventional optical modular touch screen as described above, since the plurality of infrared LEDs have to be thickly arranged at the three sides of the rectangular frame 2, it is complicated and difficult to install them, thereby increasing the installation cost thereof.

To solve the problem, there has been proposed a touch screen using a single optical guide instead of the plurality of LEDs. FIG. 2 shows the touch screen disclosed in U.S. Pat. No. 7,333,094.

As shown in FIG. 2, the touch screen includes a glass plate support, one or more optical modules, and one or more optical guides.

Since the touch screen uses the single optical guide, in which a light source like LED is disposed at both ends, instead of the plurality of LEDs, the number of components is reduced, thereby simplifying structure thereof.

However, in order to uniformly transfer light from the light source to the optical guide and smoothly pass the light through a corner of a rectangular screen in the touch screen disclosed in U.S. Pat. No. 7,333,094, it is necessary to use an optical fiber additionally having a cladding for assisting internal reflection, or to enlarge a radius of curvature of the corner of the optical guide.

In case that the optical fiber is used as the optical guide, it is possible to reduce the radius of curvature to a certain degree. However, it is not possible to sharply and perpendicularly bend the optical fiber, and thus the manufacturing cost is increased and the manufacturing process is complicated.

Since the radius of curvature of the corner of the optical guide is enlarged when applying the optical guide to the touch screen formed at a rectangular, narrow and limited space, it is difficult to practically apply it.

Meanwhile, the conventional touch screen can recognize one touch position using two optical module. However, since it is not possible to recognize multiple touch positions, its application range is restricted.

### DISCLOSURE

### Technical Problem

An object of the present invention is to provide an optical modular touch screen in which a linear infrared emitter formed of a transparent resin rod that is facilely manufactured at a low price is disposed at each side of a frame of the touch screen, instead of the plurality of infrared LEDs or the single optical guide, and edges of the frame are perpendicularly connected with each other so as to emit infrared rays, and the emitted infrared rays are detected through optical module, thereby simplifying the manufacturing and installing processes thereof and thus reducing the manufacturing cost.

Another object of the present invention is to provide an optical modular touch screen which can recognize multiple touch positions using three optical modules and four linear infrared emitters.

### Technical Solution

To achieve the object of the present invention, the present invention provides a touch screen which detects a touch position on an image screen displaying an image and executes a commend corresponding to the touch position, including a linear infrared emitter 40 which is independently disposed at least three sides 20b, 20c, 20d of frame 20 of a rectangular image screen 10 so as to emit the infrared rays; an optical module 30 which is disposed at least two or more corner portions so as to monitor the entire image screen 10; a control board 50 which analyzes an infrared signal detected by the optical module 30 and detects the touch position touched by a user.

Preferably, the linear infrared emitter 40 includes a resin rod 42 having a transparent circular shape in section and an infrared diffuse reflection line 42a in a length direction thereof, and two infrared LEDs 41 disposed at both ends of the resin rod 42 so as to emit infrared rays into the resin rod 42.

Preferably, the infrared diffuse reflection line 42a formed at the resin rod 42 is oriented to an outside of the frame 20, so that the infrared rays diffuse-reflected by the infrared diffuse reflection line 42a of the resin rod 42 are transmitted through the resin rod 42 in an opposite direction to the infrared diffuse reflection line 42a and then arrived at the optical module 30.

Preferably, the infrared diffuse reflection line 42a of the resin rod 42 is formed by applying an infrared reflecting paint, or scratching a surface of the resin rod 42 in a length direction thereof using one of a sand blast method, a laser marking method and a mechanical working method in order to induce the infrared diffuse reflection.

Meanwhile, the linear infrared emitter 40 may includes a resin rod 42 having a transparent circular shape in section and an infrared diffuse reflection line 42a in a length direction thereof, an infrared LED 41 disposed at one end of the resin rod 42 so as to emit infrared rays into the resin rod 42 and a reflecting surface which is formed at the other end of the resin rod 42 so as to reflect the infrared rays.

Preferably, at least two linear infrared emitters 40 are provided at each side of the frame 20 to be arranged in a row.

Preferably, the linear infrared emitter 40 is independently disposed at all of the four sides of the frame 20 of the rectangular image screen 10, and the optical module 30 is disposed at least three corner portions of the rectangular image screen 10.

Preferably, a corner block 25 is disposed at the corner portion of the rectangular image screen 10, in which the optical module 30 is not provided, so that the adjacent two linear infrared emitters 40 are coupled at an angle of 90°. And the infrared LED 41 is disposed at the two surfaces of the corner block 25, to which the linear infrared emitter 40 is coupled, so as to be used as a light source of the linear infrared emitter 40.

### ADVANTAGEOUS EFFECTS

In the optical modular touch screen using the linear infrared emitter according to the present invention, as described above, since the infrared rays are emitted by using the plurality of linear infrared emitters instead of the plurality of infrared LEDs or the single optical guide, and the touch position is recognized by detecting the infrared rays blocked by a user using the optical modules, it is possible to simplify the manufacturing and installing processes thereof and also to reduce the manufacturing cost. In addition, in the optical modular touch screen of the present invention, since the plurality of linear infrared emitters are perpendicularly connected by the corner block disposed at the corner portion of the frame, it is possible to minimize the surface area occupied by the touch screen.

### DESCRIPTION OF DRAWINGS

The above and other objects, features and advantages of the present invention will become apparent from the following description of preferred embodiments given in conjunction with the accompanying drawings, in which:

FIG. 1 is a view showing a construction of a conventional optical modular touch screen.

FIG. 2 is a schematic view of an optical touch screen disclosed in U.S. Pat. No. 7,333,094.

FIG. 3 is a conceptual view of an optical modular touch screen using a linear infrared emitter according to the present invention.

FIG. 4 is a partially enlarged view of an optical module according to the present invention.

FIG. 5 is an exploded view of the linear infrared emitter according to the present invention.

FIG. 6 is a perspective view of a corner block for perpendicularly connecting two linear infrared emitters according to the present invention.

FIG. 7 is a view showing an example of a passage of infrared ray reflected from an infrared diffuse reflection line which is formed at the resin rod of the linear infrared emitter according to the present invention.

FIG. 8 is a view showing an example of a passage of infrared ray radiated outside the resin rod according to the present invention.

FIG. 9 is a conceptual view of a method of detecting a touch position on an image screen according to the present invention.

FIG. 10 is a conceptual view of installation of a touch screen which recognizes multiple positions according to the present invention.

FIG. 11 is a conceptual view of a method of detecting multiple touch positions on an image according to the present invention.

FIG. 12 is a conceptual view of a method of distinguishing a real touch position from a virtual touch position generated when touching multiple positions in accordance with the present invention.

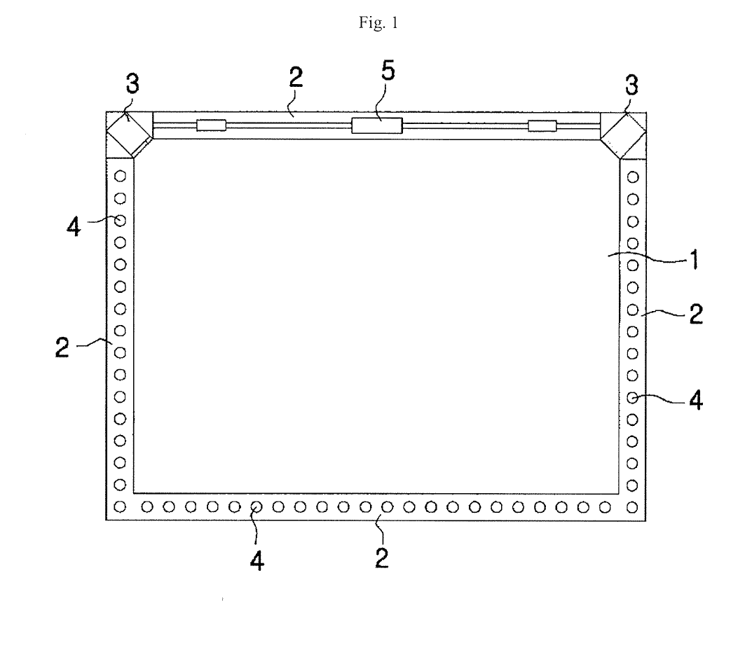

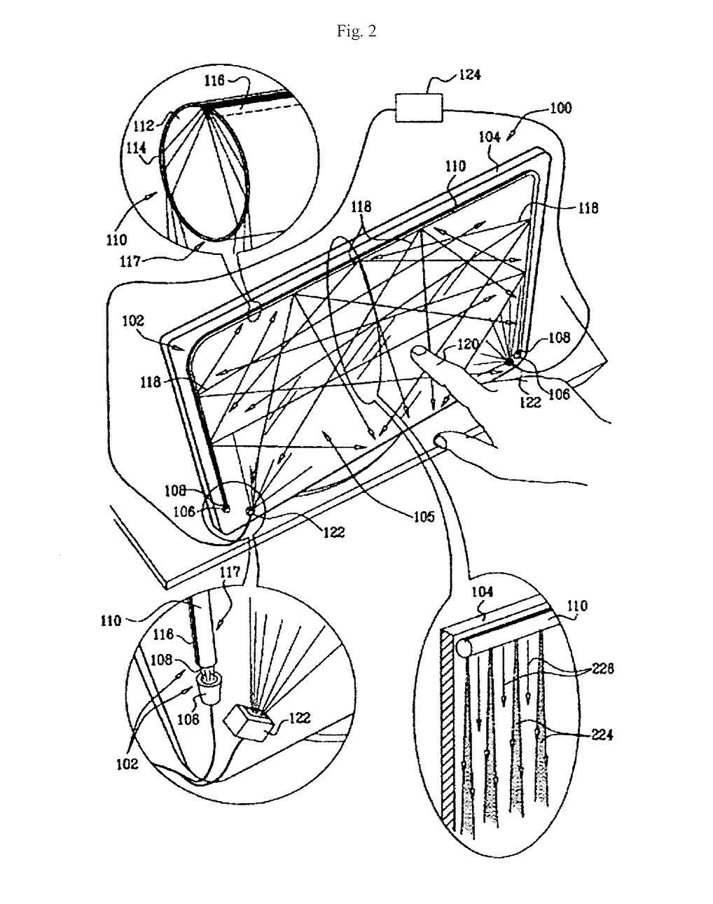

[Detailed Description of Main Elements]

10: image screen
20: frame
25: corner block
30: optical module
31: infrared filter
32: lens module
33: CMOS linear imager
40: linear infrared emitter
41: infrared LED
42: resin rod
42a: infrared diffuse reflection line
50: control board

### BEST MODE

Hereinafter, the embodiments of the present invention will be described in detail with reference to accompanying drawings.

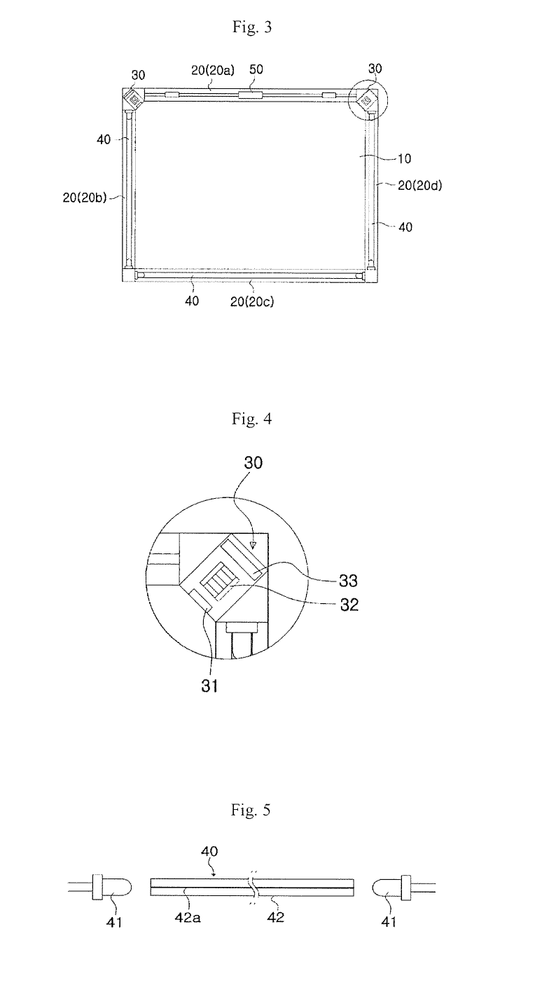

FIG. 3 is a conceptual view of an optical modular touch screen using a linear infrared emitter according to the present invention. The optical modular touch screen according to the present invention is applied to an image screen having a size of 20 or more inch.

As shown in FIG. 3, the optical modular touch screen according to the present invention includes a linear infrared emitter 40 which is disposed at each of three sides 20b, 20c and 20d of a frame 20 supporting a rectangular image screen 10 so as to emit infrared rays, a miniature optical module 30 which is disposed at both ends of the rest side of the frame 20 so as to detect the infrared rays emitted from the linear infrared emitter 40, and a control board 50 which analyzes the infrared rays detected by the miniature optical module 30 and calculates a touch position on the image screen 10 touched by a user.

The optical module 30 is a camera which linearly records an image. The optical module 30 is disposed at both ends of one side of the frame 20, i.e., at two corner portions of an upper side of the image screen 10 so as to have a visual angle of 90°, thereby monitoring the entire image screen 10. At a focal surface of the optical module 30, there is provided a CMOS linear array sensor. The CMOS linear array sensor functions to detect the infrared rays emitted from the linear infrared emitter 40. All images located within a range of the visual angle of the optical module are projected as a line segment onto the linear array sensor, and an angle of line segment of the projected image within the visual angle of 90° is decided according to a position recognized by the linear array sensor, and thus a position of the image is calculated into an angle in the optical module.

The two optical modules 30 disposed at the two corner portions read the position in the rectangular image screen 10 using the angle in the optical, respectively, and the control board 50 converts the two angles into perpendicular coordinates with respect to length and width using an angle measurement method. If the user touches a point on the image screen 10 with a finger, a touch pen and the like, the optical modules 30 detects a shadow generated when the finger blocks the infrared rays from emitted the linear infrared emitter 40, and then reads an angular position of the shadow, and the control board 50 calculates the position of the finger into the coordinates.

FIG. 4 is a partially enlarged view of the optical module according to the present invention.

As shown in FIG. 4, the optical module 30 disposed at both ends of the side 20a of the rectangular image screen 10, i.e., at each of the two corner portions includes an infrared filter 31, a lens module 32 and a CMOS linear imager 33.

The infrared filter 31 is provided at a front end of the optical module 30 so as to block out visible rays and pass the infrared rays, thereby transferring the infrared rays to the lens module 32. Therefore, the infrared filter 32 functions to prevent the unnecessary visible rays from being transferred to the optical module 30, thereby preventing confusion in a touch signal. Further, the infrared filter 31 also functions to cover and protect the lens module 32 at the front end of the optical module 30.

The lens module 32 has the visual angle of 90° or more, and imaging of the infrared rays emitted from the linear infrared emitter 40 is achieved at the CMOS linear imager 33.

The CMOS linear imager 33 is provided with the CMOS linear array sensor. The CMOS linear array sensor is connected with the control board 50 so as to transfer a detected signal of the touch position on the image screen 10 to the control board 50. The CMOS linear array sensor recognizes only as a segment all of the objects entered onto the image screen 10 through the optical module 30. When the image screen 10 is not touched, the CMOS linear array sensor continuously detects the infrared rays emitted from the linear infrared emitter 40, which is input through the lens module 32. But when the image screen 10 is touched by the finger, the touch pen and the like, the CMOS linear array sensor detects the touch position on the image screen 10. In other words, if the infrared rays emitted from the linear infrared emitter 40 to the optical module 30 is blocked by the finger, the touch pen and the like, the shadow is formed by the finger, the touch pen and the like, and the CMOS linear array sensor recognizes a position of the shadow as the signal of the touch position.

The reason why the shadow generated by the finger, the touch pen and the like using the linear infrared emitter 40 is recognized as the signal in the CMOS linear imager 33 is to minimize interference due to external light.

FIG. 5 is an exploded view of the linear infrared emitter according to the present invention.

As shown in FIG. 5, the linear infrared emitter 40 according to the present invention includes a resin rod 42 which has a transparent circular shape in section, and two infrared LEDs 41 which are disposed at both ends of the resin rod 42 so as to emit the infrared rays into the resin rod 42.

At the resin rod 42, there is formed an infrared diffuse reflection line 42a in a length direction thereof. The infrared diffuse reflection line 42a is formed by applying a white or red infrared reflecting paint.

The infrared rays emitted from the infrared LEDs 41 disposed at the both ends of the resin rod 42 are confined in the resin rod 42 clue to total internal reflection. A part of the infrared rays confined in the resin rod 42 is reflected by the infrared diffuse reflection line 42a formed in the length direction, and passed through the resin rod 42, and then radiated through an opposite surface to an outside.

Meanwhile, if the three linear infrared emitters 40 are disposed at the frame of the image screen 10, the linear infrared emitters 40 are contacted with each other at two corner portions. The corner portions where the linear infrared emitters 40 are contacted with each other may be formed into a block so as to minimize space occupation.

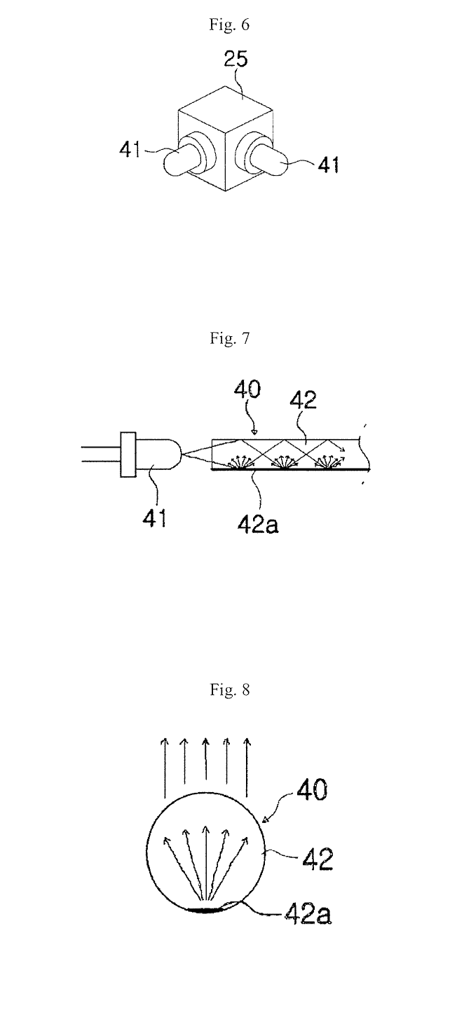

FIG. 6 is a perspective view of a corner block for perpendicularly connecting two linear infrared emitters according to the present invention. Each infrared LED 41 is disposed at two surfaces of the corner block 25 which is adjacent to each other at an angle of 90°. The linear infrared emitter 40 is coupled to the corner block 25 in which the infrared LEDs 41 are disposed at the angle of 90°.

FIG. 7 shows a passage of infrared ray reflected from an infrared diffuse reflection line which is formed at the resin rod of the linear infrared emitter, and FIG. 8 shows a passage of infrared ray radiated outside the resin rod.

As shown in FIGS. 7 and 8, the infrared rays emitted from the infrared LED 41 are total-reflected in the resin rod 42, and diffuse-reflected through the infrared diffuse reflection line 42a formed at the resin rod 42, and then radiated to an outside of the resin rod 42. A considerable part of the infrared rays radiated to the outside of the resin rod 42 is parallelly focused by a lens effect of the resin rod 42, and arrived, with a high efficiency, at the optical module 30 located at an opposite corner of the image screen 10.

Meanwhile, the linear infrared emitter 40 according to the present invention may be modified variously.

For example, the infrared LED 41 may be provided at one end of the resin rod 42, and a reflection surface like a mirror may be formed at the other end thereof so as to reflect the light without leakage of the light or the other end of the resin rod 42 may be sealed by applying a diffuse reflection paint.

Alternatively, the multiple linear infrared emitters 40 that respectively include one resin rod 42 and two LEDs 41, or one resin rod 42 and one LED 41 and one reflection surface may be disposed in the length direction so as to form one elongated emitter.

Yet alternatively, instead of forming the infrared diffuse reflection line 42a by applying the infrared reflecting paint in the length direction of the resin rod 42, fine scratch may be formed on a surface of the resin rod 42 so as to induce the reflection, thereby forming the linear structure. The method of scratching the surface of the resin rod 42 includes a sand blast method, a laser marking method, a mechanical working method and so on.

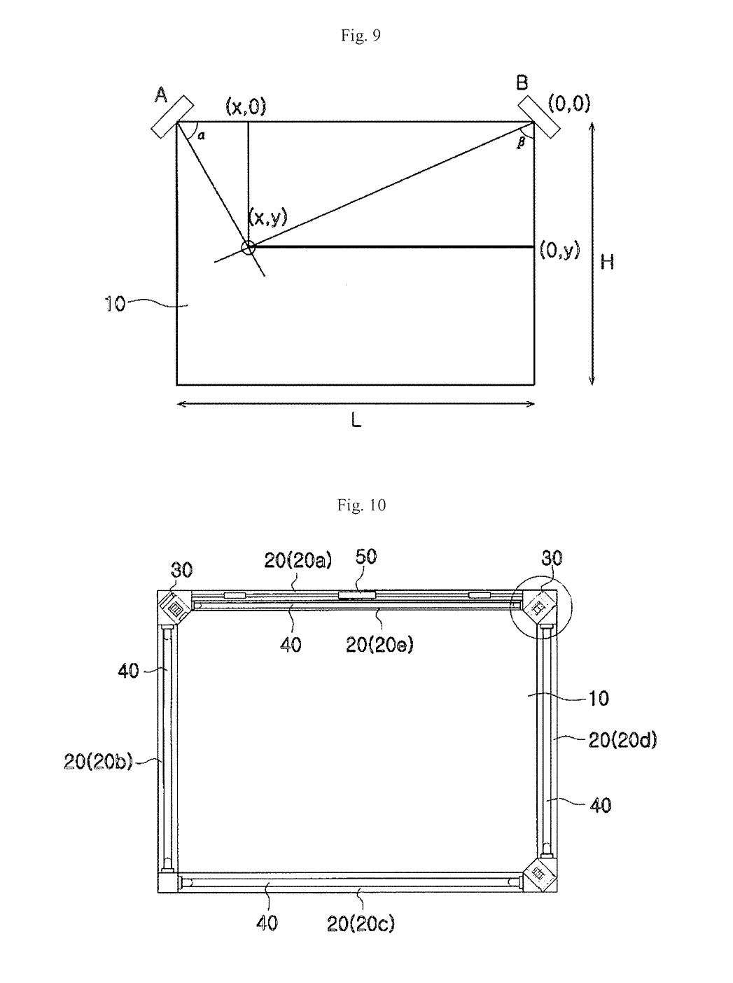

FIG. 9 is a conceptual view of a method of detecting a touch position on an image screen according to the present invention.

As shown in FIG. 9, assuming that a position of right one B out of the optical modules 30 disposed at the two corners of the image screen 10 for displaying an image is set to reference coordinates (0, 0), and a transverse length of the image screen 10 is L, and a longitudinal length thereof is H, the coordinates (x, y) of the position touched by the finger, the touch pen and the like are recognized as following equations 1 and 2 by the two optical modules A and B

tan α=y/(L−x) Equation 1

tan β=x/y Equation 2

The control board 50 detects the coordinates of the touch position using following equation 3 together with the equations 1 and 2.

x=L×tan α×tan β/(tan α×tan β+1)

y=L×tan α/(tan α×tan β+1) Equation 3

Through the equations 1, 2 and 3, the control board 50 calculates the coordinates of the touch position recognized by the optical modules 30 and then transfers them to a computer. The computer applies the coordinates of the touch position transferred through the control board 50 to the image displayed on the image screen 10 and then displays the corresponding image on the image screen 10.

In the embodiment as described above, there has been disclosed a method of grasping a signal touch position using three linear infrared emitters 40 and the two optical modules 30.

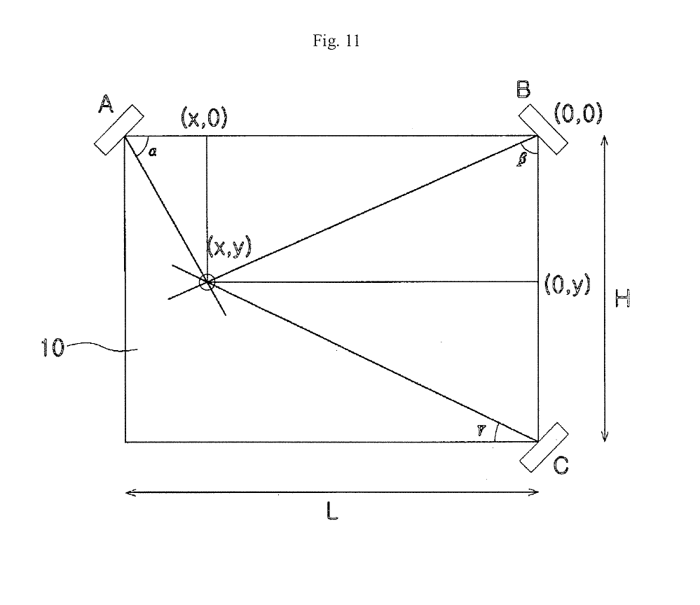

The present invention may be enlarged to recognize multi touch positions as well as the single touch position. FIG. 10 is a conceptual view of installation of a touch screen which recognizes multiple positions according to the present invention.

As shown in FIG. 10, the touch screen which recognizes multiple positions according to the present invention includes the linear infrared emitter 40 which is disposed at all sides 20b, 20c, 20d and 20e of the rectangular frame 20 defining the image screen 10, and the miniature optical module 30 which is disposed at least three corner portions of the rectangular frame 20.

At one side of the rectangular frame 20, there are provided the frame 20a for supporting a control board 50 and a supporter 20e for supporting the linear infrared emitter 40. And at the corner portion that the optical module 30 is not installed, the linear infrared emitters 40 are connected with each other through the corner block.

The two optical modules are sufficient to calculate the x and y coordinates of a single touch position. However, in order to x and y coordinates of two or more touch positions, a third optical module is further required besides the two optical modules. In the present invention, three optical modules and four linear infrared emitters are provided to recognize the multi positions.

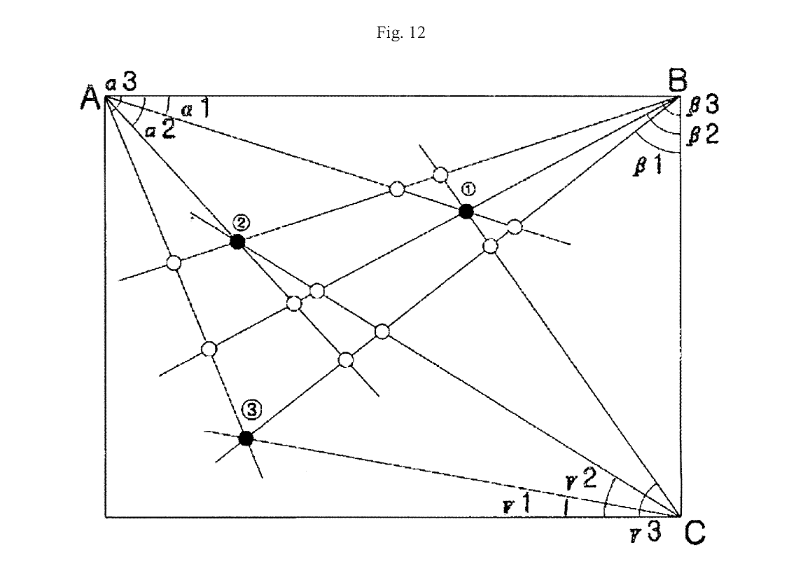

FIG. 11 is a conceptual view of a method of detecting multiple touch positions on an image according to the present invention.

If the method of calculating the coordinates (x, y) using the equations 1, 2 and 3 between the optical modules A and B, as described in FIG. 9, is applied between the optical modules B and C, C and A and the like, as shown in FIG. 11, it is possible to obtain the coordinates (x, y) of the multi positions. However, since the coordinates calculated from the three pairs of optical modules A and B, B and C, C and A includes positions of virtual touch point as well as positions of real touch point, it is necessary to separate the virtual touch positions from the real touch positions using a logical method.

FIG. 12 is a conceptual view of a method of distinguishing the real touch positions from the virtual touch positions generated when touching multiple positions in accordance with the present invention.

In FIG. 12, if three touch positions \textcircled{1}, \textcircled{2} and \textcircled{3} are generated at the same time, the optical module A detects angles α1, α2 and α3, and the optical module B detects angles β1, β2, β3, and the optical module C detects angles γ1, γ2, γ3. If each of the detected angles is applied to the equations 1, 2 and 3, it is possible to calculate multiple coordinate groups. Out of the multiple coordinates calculated by the equations, only the three positions \textcircled{1}, \textcircled{2} and \textcircled{3} are the real touch positions, and the rest are the virtual touch positions that exist only in the calculation.

Therefore, it will be understood that the real touch positions are obtained by selecting the coordinates coincident with each other from the coordinates calculated by the pair of optical modules A and B and other coordinates calculated by the pair of optical modules B and C, C and A.

Accordingly, the touch screen of the present invention recognizes the multi touch positions as well as the single touch position touched by the user.

The present application contains subject matter related to Korean Patent Application No. 2008-0100111, filed in the Korean Intellectual Property Office on Oct. 13, 2008, the entire contents of which is incorporated herein by reference.

While the present invention has been described with respect to the specific embodiments, it will be apparent to those skilled in the art that various changes and modifications may be made without departing from the spirit and scope of the invention as defined in the following claims.

### INDUSTRIAL APPLICABILITY

The optical modular touch screen using the linear infrared emitter has advantages that it is cheap and easy to install it due to its simple construction, and it is possible to minimize the space occupation of the touch screen, and thus it is possible to be widely used instead of the conventional touch screen.

1. A touch screen which detects a touch position on an image screen displaying an image and executes a commend corresponding to the touch position, comprising:
a linear infrared emitter which comprises a resin rod having a transparent circular shape in section and an infrared diffuse reflection line in a length direction thereof, and two infrared LEDs disposed at both ends of the resin rod so as to emit infrared rays into the resin rod, and which is independently disposed at least three sides of frame of a rectangular image screen so as to emit the infrared rays;
an optical module which is disposed at least two or more corner portions so as to monitor the entire image screen;
a control board which analyzes an infrared signal detected by the optical module and detects the touch position touched by a user.

2. The touch screen of claim 1, wherein the infrared diffuse reflection line formed at the resin rod is oriented to an outside of the frame so that the infrared rays diffuse-reflected by the infrared diffuse reflection line of the resin rod are transmitted through the resin rod in an opposite direction to the infrared diffuse reflection line and then arrived at the optical module.

3. The touch screen of claim 1, wherein the infrared diffuse reflection line of the resin rod is formed by applying an infrared reflecting paint in order to induce infrared diffuse reflection.

4. The touch screen of claim 1, wherein the infrared diffuse reflection line of the resin rod is formed by scratching a surface of the resin rod in a length direction thereof using one of a sand blast method, a laser marking method and a mechanical working method in order to induce the infrared diffuse reflection.

5. A touch screen which detects a touch position on an image screen displaying an image and executes a command corresponding to the touch position, comprising:
a linear infrared emitter which comprises a resin rod having a transparent circular shape in section and an infrared diffuse reflection line in a length direction thereof, an infrared LED disposed at one end of the resin rod so as to emit infrared rays into the resin rod and a reflecting surface which is formed at the other end of the resin rod so as to reflect the infrared rays, and which is independently disposed at least three sides of frame of a rectangular image screen so as to emit the infrared rays;
an optical module which is disposed at least two or more corner portions so as to monitor the entire image screen;
a control board which analyzes an infrared signal detected by the optical module and detects the touch position touched by a user.

6. The touch screen of claim 5, wherein at least two linear infrared emitters are provided at each side of the frame to be arranged in a row.

7. The touch screen of claim 5, wherein the linear infrared emitter is independently disposed at all of the four sides of the frame of the rectangular image screen, and the optical module is disposed at least three corner portions of the rectangular image screen.

8. The touch screen of claim 5, wherein a corner block is disposed at the corner portion of the rectangular image screen, in which the optical module is not provided, so that the adjacent two linear infrared emitters are coupled at an angle of 90°.

9. The touch screen of claim 8, wherein the infrared LED is disposed at the two surfaces of the corner block, to which the linear infrared emitter is coupled, so as to be used as a light source of the linear infrared emitter.

10. The touch screen of claim 1, wherein at least two linear infrared emitters are provided at each side of the frame to be arranged in a row.

11. The touch screen of claim 1, wherein the linear infrared emitter is independently disposed at all of the four sides of the frame of the rectangular image screen, and the optical module is disposed at least three corner portions of the rectangular image screen.

12. The touch screen of claim 1, wherein a corner block is disposed at the corner portion of the rectangular image screen, in which the optical module is not provided, so that the adjacent two linear infrared emitters are coupled at an angle of 90°.

13. The touch screen of claim 12, wherein the infrared LED is disposed at the two surfaces of the corner block, to which the linear infrared emitter is coupled, so as to be used as a light source of the linear infrared emitter.
